(19) United States
(12) Patent Application Publication
(10) Pub. No.: US 2006/0034475 A1
(43) Pub. Date: Feb. 16, 2006

(54) Compression driver plug

(76) Inventor: Earl Rossell Geddes, Northville, MI (US)

Correspondence Address: Earl Geddes, 43516 Scenic LN., Northville, MI, 48167, US

(21) Appl. No.: 10/919,145

(22) Filed: Aug. 16, 2004

(51) Int. Cl. H04R 1/02; H04R 1/20

(52) U.S. Cl. 381/343; 381/337

(57) ABSTRACT

An improved phase plug for a compression driver which has a wavefront at its exit aperture that is uniform in both amplitude and phase. An alternative phase plug wherein the velocity distribution in the exit aperture is specified in both magnitude and phase. The improved phase plug results in an improved coupling to the waveguide for better directivity control.

### CROSS-REFERENCE TO RELATED APPLICATIONS

This application claims the benefit of U.S. provisional application Ser. No. 60/______ filed Aug. 16, 2003.

### FIELD OF THE INVENTION

The present invention pertains to the phase plug in a compression driver placed between the diaphragm and the waveguide or horn whose function is to provide for equal path lengths from the diaphragm to the exit aperture of the phase plug—the input aperture to the waveguide.

### BACKGROUND OF THE INVENTION

In the area of audio loudspeakers it is not uncommon to use compression drivers for mid to upper frequencies. There are two main reasons for this. First, the compression driver, when coupled to a waveguide (in this application the terms waveguide and horn are synonymous), provides for much higher electro-acoustical efficiency than a direct radiating loudspeaker can achieve. Second, the waveguide provides for a better control over the directional characteristics of the sound radiation than can be achieved with a direct radiator loudspeaker. In both cases at higher frequencies, where the wavelength of the sound begins to approach the dimensions of the throat of the waveguide, it is important for the wavefront presented to the waveguide to be approximately flat (uniform in phase), otherwise frequency response aberrations and poor directivity control will result.

The usual goal of a phasing plug is to create a flat wavefront at its exit aperture. This was most elegantly stated by Wente in his hallmark U.S. Pat. No. 2,037,187: “In order to insure uniform reproduction of a wide range of frequencies . . . means are provided . . . for preventing suppression of . . . higher frequencies. To this end a multi-sectional acoustic transducer or plug is provided intermediate one surface of the diaphragm and the end of the horn in acoustic communication with the surface.” Later in the patent He goes on to state, “The several elements noted are so proportioned that the passageways formed thereby are of substantially equal length and are equally spaced at the ends towards the diaphragm. This construction provides a plurality of paths of substantially equal length so that sound waves emanating from all points of the central portion of the diaphragm traverse paths substantially the same length in passing to the throat of the horn and hence arrive at the throat of the horn substantially in phase. Another feature of this construction is that a substantially plane wave front is obtained at the end of the bore directed toward the diaphragm.” This design philosophy has remained the principle one in virtually every circumferential phase plug design in use today and was even recently reinforced by Bie in U.S. Pat. No. 5,117,462 where he references the Wente design as “perhaps the most frequently used . . . ”

Modifications to the Wente design have been seen, primarily in the use of holes as equalizing paths, or radial slots, see Henrickson, U.S. Pat. No. 4,050,541. The present application is concerned with improvements and corrections to phase plug designs of the annular ring variety.

The single most significant contribution to phase plug design after Wente was put forth by Smith (“An Investigation of the Air Chamber of Horn Type Loudspeakers”, Jour. Of the Acoustical Soc. of Amer., Vol. 25 no. 2, Mar. 1953) and later adopted by Murray (Audio Engineering Society Preprint no. 1384, November 1978). Smith developed a design approach whose goal was the suppression of radial modes in the circular chamber in front of the diaphragm. Following his design approach, the ring areas and their radial location at the diaphragm are variables in the equations that Smith uses and they can therefore be of any value. However, one will obtain areas and radii of the sound channel entrances at the diaphragm which will tend to be nearly equally spaced and will appear to have approximately equal gap widths. This means that the sound channel entrance areas will actually vary from the inner ring to the outer ring, and these areas tend to get larger as they move away from the axis. In the Smith design approach no mention is made of how to place the ends of the annular rings at the exit aperture of the phase plug. This is left to the designer's discretion.

There is a serious error in all of the prior art as regards the phase plug design, which has heretofore gone unchallenged, and it is to be found in the statements of Wente. Wente concludes that making sound channels of equal length will yield a plane wave front at the exit aperture of the phase plug, but this is incorrect. The prior art approachs will generally yield a wavefront of constant phase angle across this surface, but placing the “passageways . . . equally spaced at the ends towards the diaphragm” will cause the wavefront to have a non-uniform volume velocity across this equal phase surface unless extreme care is taken at the exit aperture to allow for the different volume velocities that will occur in each channel when this approach is taken.

Indeed, what Wente and the others have missed is the fact that to be a true plane wave one must have both a uniform phase and uniform velocity amplitude in the surface. Wente's discussion and his design approach will only ensure, or allow for, the phase to be uniform, but not the velocity magnitude. Neither Smith nor Murray offer any method for making the wavefront at the exit aperture uniform in velocity magnitude and no indication is made that they even recognized this to be important. Of course for low frequencies, where the wavelengths are large compared to the exit aperture there cannot be anything but uniform velocity in the surface, so the traditional approach is perfectly correct. However, at higher frequencies, where the wavelengths are comparable to the exit aperture's dimensions, there can be a substantial deviation of the velocity magnitude from uniform across the exit aperture.

Further to this discussion, the entire prior art relied on the prevailing theory of horns attributed to Webster and known as Webster's Horn Equation. This theory makes the assumption of uniform velocity across the horn device throughout its length so it is natural not to take into consideration any deviation of the velocity amplitude from uniform at the horns throat, usually the phase plugs exit aperture.

Not until Geddes showed through his work on waveguides (see Chapter 6 of Audio Transducers, GedLee Publishing, 2002 ISBN 0-9722085-0-X) was the importance of the velocity amplitude distribution (in addition to the phase) at the throat of the waveguide recognized. Geddes showed that higher order modes exist in all waveguides and that they play a dominate role in wave propagation in a waveguide at the higher frequencies. In order to control the high frequency polar response one has to control the excitation and propagation of the higher order modes and hence the distribution of these modes at the throat. Clearly the wavefront at the exit aperture of the phase plug, which becomes the throats input wavefront, must be controlled more precisely than by just adjusting the phase across this wavefront. This significant point is missing from the entire body of prior art designs for phase plugs.

FIG. 1 shows a simplified drawing of a typical phase plug (40) in the current art. A diaphragm (20) is shown along with a means of flexible support (30). A means for driving this diaphragm is not shown since these are not germane to the discussion, but one would have to be applied to a functional compression driver. Four annular sound channels (50) are shown terminating at the diaphragm and the exit aperture (70). The entrances of the sound channels at the diaphragm (10) are radially spaced either equally (according to Wente) or as solutions of a Bessel function matrix (according to the Smith approach). The widths of the entrances of the sound channels are substantially equal for all of the channels, but the areas vary according to Smith. The lengths should be substantially equal. The phase plug terminates at the entrance to the horn or waveguide (60) at the exit aperture. The details of the sound channels exits (15) are not specified by either the Wente or the Smith design procedures. They are usually equally spaced, but are never spaced in a manner which gives a controlled complex velocity distribution in the exit aperture.

It is the purpose of this invention to disclose an improved circumferential phase plug design which has the ability to create a wavefront in the exit aperture which can be manipulated in both amplitude and phase.

### SUMMARY OF THE INVENTION

The present invention is a compression driver phase plug of the concentric annulus channel variety which has the locations and the width of the inlet of these channels specified in such a way so as to create a wavefront in the exit aperture of this phase plug that has a prescribed amplitude and phase of the velocity in this surface. These design constraints are accomplished by considering the diaphragm and the exit aperture to be composed of Fresnel zones. In the Fresnel zone concept, each zone is of equal area. The number of zones is arbitrary except that there should be the same number at the diaphragm and the exit aperture and there are the same numbers of concentric annulus channels as Fresnel zones.

This application is concerned with the details of the acoustic wave generated by the compression driver's diaphragm as it passes through what will be called the phase plugs exit aperture. This surface is usually of circular or circular annular cross section, although it can be any other shapes as well, most notably elliptical or rectangular. In this application the exit aperture will always be refereed to as being of circular cross section although the extension of the techniques disclosed herein to other shapes would be obvious. Usually, the phase plugs exit aperture is identical to the waveguides throat, or entrance, the two devices join these two mating surfaces together in actual usage. Although, it can be the case that the waveguide contour actually extends down into the phase plug and in this case the phase plugs exit aperture is actually within the body of the waveguide and the waveguides throat would lie at of near the driver's diaphragm. This detail has no effect on the techniques that will be disclosed herein, except to alter the locations of where the exit aperture of the phase plug and the throat of the waveguide reside relative to one another.

When the diaphragm is moving with a uniform velocity then each Fresnel zone at the diaphragm with have the same volume velocity. Each annular channel couples a corresponding input Fresnel zone, on the diaphragm with an output Fresnel zone in the exit aperture. The Fresnel zones correspondence between the diaphragm and the exit aperture identically from the inner to outer zone. That is, the inner zone on the diaphragm couples to the inner zone in the exit aperture, the next one to the next one and so forth out to the outer most zone. The simplicity and usefulness of this approach are obvious.

Each channel carries an identical volume velocity from the diaphragm to the exit aperture and when the channel outlets correspond to Fresnel zones then each Fresnel zone in the exit aperture will carry an identical volume velocity and hence a uniform velocity distribution in the aperture. A slight modification of these same techniques allows for the specification of a close approximation to any velocity distribution in the exit aperture.

If the exit aperture is a rectangle then the Fresnel zones are nested rectangles and if it is elliptical then they are concentric ellipses, but otherwise the techniques are invariant with the shape of the exit aperture.

In one preferred embodiment, the location of an annular channels inlet, at the diaphragm, is placed essentially at the centroid of its corresponding Fresnel zone. The centroid line of a zone which divides the zone into two equal area parts.

In one preferred embodiment, the areas of all the channels are equal from the diaphragm to the exit aperture, but this area need not be constant. The channels area can change along their length and this would be desirable if it is done in a manner which makes the total channel area continuous from the waveguide that will be attached to the exit aperture back to the diaphragm.

According to the present invention, a compression driver phase plug is provided. The driver plug compromises a first surface having a plurality of apertures facing a compression driver diaphragm, a second surface having a respective plurality of apertures facing a horn or waveguide and a respective plurality of channels. The apertures of the first surface are in fluid communication with the respective plurality of apertures of the second surface via the channels. The apertures of the first surface, the apertures of the second surface, and the channels are sized such that the driver plug provides a controlled phase and velocity amplitude of the wavefronts that are presented to the horn or waveguide.

The channels areas can also remain constant along their length. The lengths of the channels are adjusted to remain substantially constant from channel to channel although variables channel lengths can be used to modify the phase of the velocity distribution in the exit aperture in an obvious way. In this preferred embodiment, equal areas of the diaphragm are coupled through the annular sound channels to equal areas in the exit aperture, in phase, thus ensuring that a uniform complex (magnitude and phase) velocity distribution will exist in the exit aperture, so long as a uniform complex velocity exits at the diaphragm (which is the design goal of a compression driver diaphragm).

In another preferred embodiment a non-uniform velocity is created in the exit aperture by adjusting the input Fresnel zone areas and the channel lengths to yield the desired velocity distribution. The procedure is a slight modification of the procedure given above.

### DRAWING FIGURES

FIG. 1 shows a drawing of the prior art in phase plug design.

FIG. 2 shows a layout of Fresnel zones with a unit area for four zones.

FIG. 3 shows a table of Fresnel rings and centroid values for three values of N, the number of annular rings.

FIG. 4 shows a drawing of the new phase plug design along with the Fresnel zones and the layout lines.

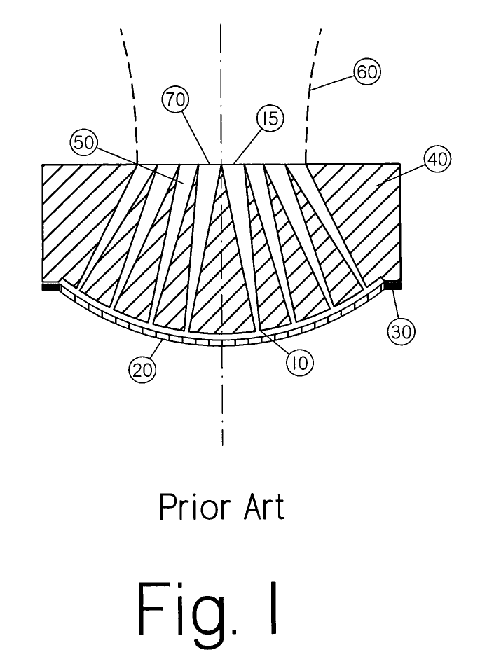

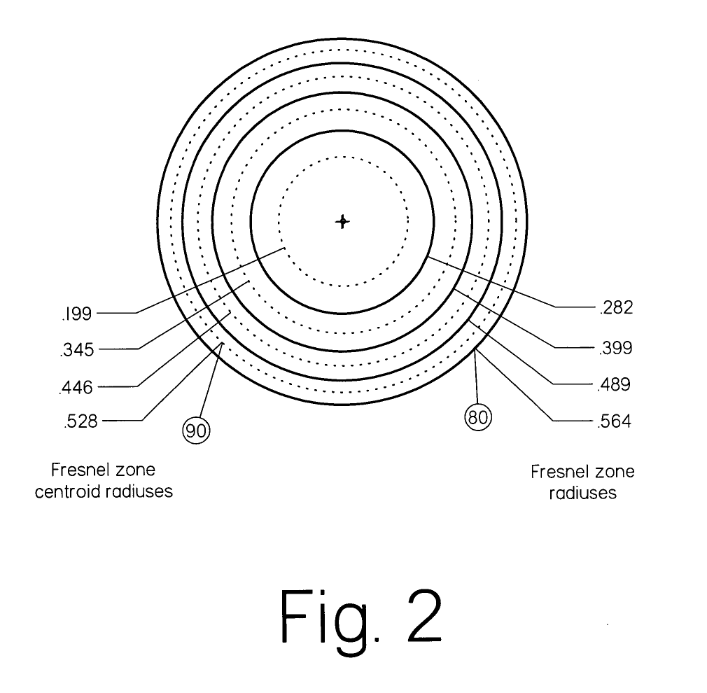

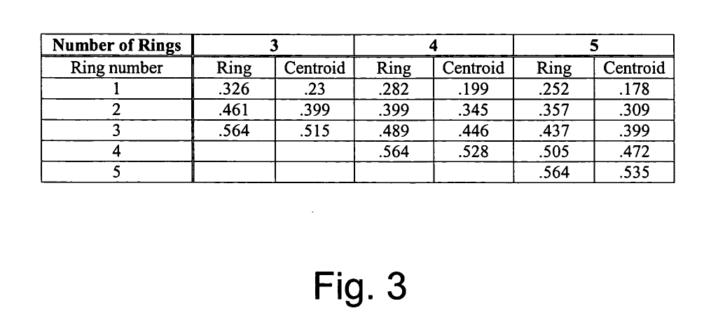

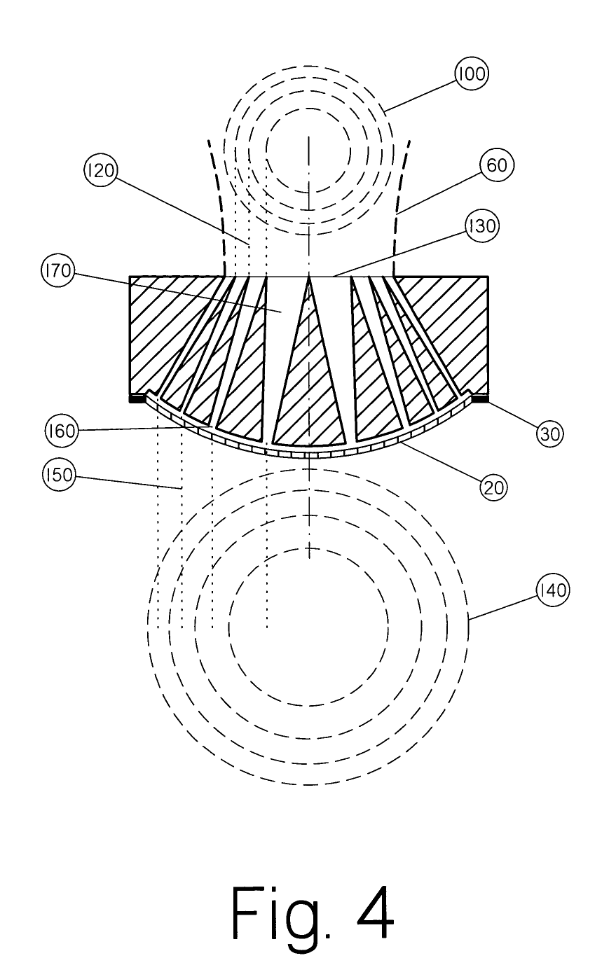

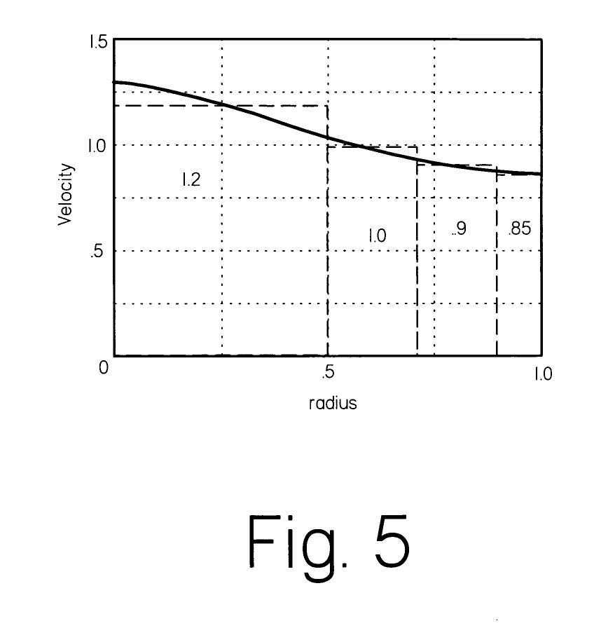

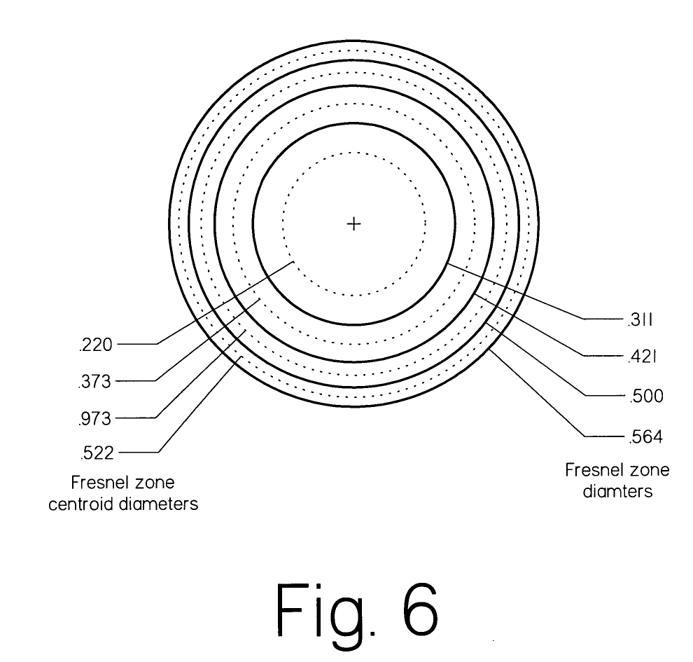

### DETAILED DESCRIPTION OF THE PREFERRED EMBODIMENT

It is the purpose of this invention to disclose an improved circumferential phase plug design which has the ability to create a wavefront in the exit aperture which can be manipulated in both amplitude and phase.

FIG. (2) shows an example of Fresnel zones laid out on a circle of unit area. There are four zones in this example and each zone is therefore one quarter of the total circular area. The radiuses of the four zones are shown (80), as well as the zone centroid radiuses (90). These values can also be found in the table of FIG. (3), along with values for three and five zones. The layouts of the Fresnel zones form the starting point for the layout of a phase plug of the new design.

FIG. (4) shows the design approach according to the new invention. Both the exit aperture (130) and the diaphragm (20) are aligned with Fresnel zone layouts, (100) and (140) respectively. Note that the Fresnel zones for the diaphragm are based on the projected areas and not on the areas in the diaphragms spherical surface. Each Fresnel zone in the diaphragm is matched to a Fresnel zone in the exit aperture.

The location of the entrance to the sound channels (160) is found by using the zone centroids from the table projected to the diaphragm (150). The width of the sound channel entrances is such that the area of each entrance is identical and the sum of the areas of all of the channels is equal to the area of the diaphragm divided by the desired compression ratio.

The locations of the sound channel exits is such that a projection of the Fresnel zones (120) from the Fresnel zone layout (100) will exactly place the junctions between successive channels. In this way each Fresnel zone projected onto the diaphragm area is mapped to a Fresnel zone in the phase plugs exit aperture.

In another preferred embodiment, variations on the above design procedure are also possible and advantageous. In his book Audio Transducers, (FIG. 6-12) Geddes shows how one might want to have a non-uniform velocity amplitude distribution in the exit aperture. An example target aperture velocity profile as a function of the normalized exit aperture radius is shown in FIG. (5).

According to the present invention, a compression driver phase plug is provided. The driver plug compromises a first surface having a plurality of apertures facing a compression driver diaphragm, a second surface having a respective plurality of apertures facing a horn or waveguide and a respective plurality of channels. The apertures of the first surface are in fluid communication with the respective plurality of apertures of the second surface via the channels. The apertures of the first surface, the apertures of the second surface, and the channels are sized such that the driver plug provides a controlled phase and velocity amplitude of the wavefronts that are presented to the horn or waveguide.

Using the number of channels as four (in this example), the desired velocity amplitudes for the four Fresnel zones are shown graphically as the boxes where the numbers in them represent the desired velocity values. These values represent the velocity in each Fresnel zone that most closely matches the value of the prescribed curve on the average across the box and such that the sum of the numbers adds up to be the number of annulus channels. These numbers represent the weights for a set of modified Fresnel zones that will be created at the diaphragm.

Using the weights, as calculated above, the Fresnel zones areas for the diaphragm Fresnel zone layout diagram (140) are modified as follows: the zone areas are no longer made equal, but instead they are proportional to the diaphragm area divided by the number of channels times the weight. This is a trivial calculation to perform and can be done with a calculator. These calculations result in new zone areas and centroids as shown in FIG. (6). This figure shows the new Fresnel layout required for the desired velocity modification. FIG. (6) should be compared to FIG. (2) where it can clearly be seen that the central zone areas have grown in size while the outer zone areas have decreased. The new areas and locations of the channel entrances will cause the volume velocity of the central zone at the exit aperture to increase since it now covers a larger diaphragm area (assuming that the diaphragm has a uniform velocity). Other modifications to this approach are possible and will be apparent to those proficient in the art.

I claim:

1) A compression driver phase plug, the driver plug compromising:
a first surface having a plurality of apertures facing a compression driver diaphragm;
a second surface having a respective plurality of apertures facing a horn or waveguide;
and a respective plurality of channels, wherein the apertures of the first surface are in fluid communication with the respective plurality of apertures of the second surface via the channels, and the apertures of the first surface, the apertures of the second surface, and the channels are sized such that the driver plug provides control of the velocity amplitude and phase of the wavefronts that are presented to said horn or waveguide.

2) The compression driver phase plug of claim 1 wherein;
the channel lengths and areas are adjusted so as to yield a complex velocity in the plane of the exit aperture which is essentially uniform in magnitude and phase.

3) The compression driver phase plug of claim 1 wherein;
the channel lengths and areas are adjusted to yield a complex velocity in the plane of the exit aperture which is essentially uniform in magnitude but which has a phase delay that increases with the distance of the channel from said plugs central axis.

4) The compression driver phase plug of claim 1 wherein;
the channel lengths and areas are adjusted to yield a complex velocity in the plane of the exit aperture which is essentially uniform in phase but has a magnitude which varies within said plane.

5) The compression driver phase plug of claim 1 wherein;
the channel lengths and areas are adjusted to yield a complex velocity in the plane of the exit aperture that has a magnitude and phase which varies in a prescribed manner within said plane.
